(19) United States
(12) Patent Application Publication
(10) Pub. No.: US 2016/0001719 A1
(43) Pub. Date: Jan. 7, 2016

(54) Charging Method

(71) Applicant: JAGUAR LAND ROVER LIMITED, Coventry, Warwickshire (GB)

(72) Inventors: Jeremy Frost, Coventry (GB); Baptiste Bureau, Coventry (GB)

(21) Appl. No.: 14/767,369

(22) PCT Filed: Feb. 13, 2014
(86) PCT No.: PCT/EP14/52767

§ 371 Date: Aug. 12, 2015

(30) Foreign Application Priority Data
Feb. 13, 2013 (GB) 1302499.7

(51) Int. Cl. B60R 16/033; H02J 7/00

(52) U.S. Cl. CPC B60R 16/033; H02J 7/007; H02J 7/0054; H02J 7/0022; H02J 7/0021

(57) ABSTRACT

In accordance with the present invention there is provided an engine (100), the engine (100) having a first mode and a second mode, the engine (100) comprising: a first battery (101); a second battery (102); a first charge level monitoring device (106) attached to the first battery (101); and a control unit (105). The control unit (105) is arranged to: measure the charge level of the first battery (101) using the first charge level monitoring device (106) when the engine (100) is in the second mode; and cause the second battery (102) to charge the first battery (101) if the charge level of the first battery (101) is beneath a first threshold value.

### TECHNICAL FIELD

This invention relates to a charging method for a vehicle and particularly, but not exclusively, to an engine, a method and a control unit for charging a battery in an engine.

### BACKGROUND

Modern vehicles have an increasing number of electrical components. A car, for example, may have electrically powered steering, windows, heating and cooling systems, engine management systems, and many other electrical components. Many of these components have a minimum current which they draw even when the vehicle is in an “off” mode. For example, timing devices such as clocks must continue to track the passing of time, and key sensors must continue to monitor for unlock signals from a remote key. As such, the electrical system's draw upon a modern vehicle's batteries is never zero. The current drawn while the vehicle is turned off is referred to as the quiescent current.

Any batteries in a vehicle are monitored while the vehicle is in an “on” state, and steps can be taken to recharge the batteries as necessary. However, although the quiescent current is minimal, over time it can still drain a vehicle's batteries. This may happen particularly if the vehicle is left unattended for a long period of time, for example because the owner is on holiday. If the battery is drained significantly, the vehicle may be unable to start up, operate safely, or even unlock.

A way of reducing this risk is therefore desirable.

### SUMMARY OF THE INVENTION

In accordance with one aspect of the present invention there is provided an engine, the engine having a first mode and a second mode, the engine comprising: a first battery; a second battery; a first charge level monitoring device attached to the first battery; and a control unit. The control unit is arranged to: measure the charge level of the first battery using the first charge level monitoring device when the engine is in the second mode; and cause the second battery to charge the first battery if the charge level of the first battery is beneath a first threshold value.

Typically, the control unit will be arranged to not cause the second battery to charge the first battery while the engine is in the second mode otherwise.

With the increasing popularity of hybrid and electric vehicles, the electrical architecture of vehicles is becoming ever more complex. In particular, most hybrid and electrical vehicles contain at least two batteries. An engine or a method as described herein can ensure that a first battery stays charged even as current is drawn by a quiescent current, since the first battery can be charged from the second battery as necessary.

The engine is a system which can convert stored energy into mechanical motion. The first mode of the engine may be an on mode. An on mode refers to a mode in which the engine is converting stored energy into mechanical motion. The second mode of the engine may be an off mode. An off mode refers to a mode in which the engine is not converting stored energy into mechanical motion. Typically, in the off mode at least some and possibly all electrical systems within the engine are set to a standby or off mode of their own in which the current they draw is minimised. It may be that the first battery provides a quiescent current to at least one system while the engine is in the off mode.

Alternatively, the second mode may refer to a mode in which neither the first or second batteries is undergoing heavy use. For example, in a hybrid vehicle which is capable of being driven by burning fuel, it may be that the vehicle is in a second mode while being driven, provided that the vehicle is burning fuel to drive, and is not depending upon the first or second batteries.

It may be that the second battery is arranged to charge the first battery only if the engine is not connected to an external power source. The control unit may be arranged to: determine if an external power supply is available; cause the external power supply to charge the first battery if an external power supply is available and the charge level of the first battery is beneath a first threshold value; and cause the second battery to charge the first battery if an external power supply is not available and the charge level of the first battery is beneath a first threshold value.

Typically, the control unit is arranged to charge the first battery until the charge level of the first battery is above a second threshold value. The second threshold value may be the same as the first threshold value. Typically, the second threshold value is higher than the first threshold value.

It may be that the control unit is arranged to measure the charge level of the second battery and cause the second battery to charge the first battery only if the charge level of the second battery is above a third threshold value.

It may be that a control unit is also arranged to measure the charge level of the second battery when the engine is in the second mode; and cause the first battery to charge the second battery if the charge level of the second battery is beneath a fourth threshold value.

It may be that the control unit is arranged to provide a warning to a user if the rate of change of the measured charge of the first battery while the first battery is discharging is above a fifth threshold value. For example, it may be that the battery or some other part of the electrical system has been damaged and this is causing the battery to loose charge excessively fast so that it needs to be charged more frequently.

It may be that the control unit is arranged to provide a warning to a user if the rate of change of the measured charge of the first battery while the first battery is charging is beneath a sixth threshold value. The battery or some other part of the electrical system might be damaged in such a way as to cause the battery to gain charge excessively slowly.

In either of the above two cases a warning could be issued to the user so that they know that the engine should be inspected.

It may be that the control unit is arranged to provide a warning to a user if the first battery cannot be charged. For example, it may be that the charge of the second battery is too low to allow a charging of the first battery. It may be that the control unit is arranged to provide a warning to a user if the charge of the first battery drops below a seventh threshold value. Hence the user can take action before the battery charge drops too low.

It may be that the control unit is arranged to wait a predefined period of time after the engine is set to the second mode before measuring the charge level of the first battery. Alternatively, the first control unit may measure the charge level of the first battery immediately after shut down of the engine.

The control unit may be arranged to wait a predefined period of time after measuring the charge level of the first battery before measuring the charge level of the first battery again. Where the battery is charged, it may be that the control unit is further arranged to wait a predefined period of time after the first battery is charged before measuring the charge level of the first battery again. Alternatively, the first control unit may measure the charge level of the first battery substantially continuously.

Where the control unit is arranged to wait a predefined period of time, the control unit may be further arranged to select the length of the predefined period of time dependent upon the measured charge of the first battery. The control unit may also be arranged to select the length of the predefined period of time dependent upon the previously measured rate of change of the charge in the battery while discharging.

A second aspect of the present invention provides a method for charging a battery in an engine, the engine having a first mode and a second mode. The engine comprises: a first battery; a second battery; a first charge level monitoring device attached to the first battery; and a control unit. The method comprises: measuring the charge level of the first battery using the first charge level monitoring device when the engine is in the second mode; and causing the second battery to charge the first battery if the charge level of the first battery is beneath a first threshold value.

Typically, the method further comprises not causing the second battery to charge the first battery while the engine is in the second mode otherwise.

The method may further comprise: determining if an external power supply is available; causing the external power supply to charge the first battery if an external power supply is available and the charge level of the first battery is beneath a first threshold value; and causing the second battery to charge the first battery if an external power supply is not available and the charge level of the first battery is beneath a first threshold value.

Typically, the method comprises charging the first battery until the charge level of the first battery is above a second threshold value. The second threshold value may be the same as the first threshold value.

The method may further comprise:
measuring the charge level of the second battery; and
causing the second battery to charge the first battery only if the charge level of the second battery is above a third threshold value.

The method may further comprise measuring the charge level of the second battery when the engine is in the second mode; and causing the first battery to charge the second battery if the charge level of the second battery is beneath a fourth threshold value.

It may be that the method further comprises providing a warning to a user if the rate of change of the measured charge of the first battery while the first battery is discharging is above a fifth threshold value. For example, it may be that the battery or some other part of the electrical system has been damaged and this is causing the battery to loose charge excessively fast. In this case the battery would drop below the first threshold and need to be charged more frequently, or not at all if the rate of discharge of the second battery is such as to suggest a sufficient fault that recharging from the second battery will merely waste available charge in the second battery.

It may be that the method further comprises providing a warning to a user if the rate of change of the measured charge of the first battery while the first battery is charging is beneath a sixth threshold value. The battery or some other part of the electrical system might be damaged in such a way as to cause the battery to gain charge excessively slowly.

In either of the above two cases a warning could be issued to the user so that they know that the engine should be inspected.

It may be that the method further comprises providing a warning to a user if the first battery cannot be charged. It may be that the method further comprises providing a warning to a user if the charge of the first battery drops below a seventh threshold value.

The method may comprise waiting a predefined period of time after the engine is set to the second mode before measuring the charge level of the first battery. Alternatively, the first control unit may measure the charge level of the first battery immediately.

The method may further comprise waiting a predefined period of time after measuring the charge level of the first battery before measuring the charge level of the first battery again. Where the first battery is charged, the method may further comprise waiting a predefined period of time after the first battery is charged before measuring the charge level of the first battery again. Alternatively, the method may comprise measuring the charge level of the first battery substantially continuously.

It may be that the first charge level monitoring device is attached to the second battery. The control unit may be arranged to measure the charge level of the second battery using the first charge level monitoring device. It may be that a second charge level monitoring device is attached to the second battery. The control unit may be arranged to measure, or the method may comprise measuring, the charge level of the second battery using the second charge level monitoring device.

A warning issued to the user may comprise a local message. A local message may comprise a warning displayed on the dashboard. A local message may comprise an external indicator, such as a light on the flap covering the vehicle's charging connector. A warning issued to the user may also comprise a remote message, such as a message sent to a mobile phone.

In either the method or the engine described above, the predefined period of time may be predetermined. For example, the predefined period of time may be an hour, or six hours, or one day, or six days or a week. The predefined period of time may vary with time. For example, the predefined period of time may be first a week, then a day, and then an hour. The predefined period of time may then remain an hour until the first battery is next charged. The predefined period of time may then reset so that it is first a week, then a day and then an hour again.

The length of the predefined period of time may depend upon the measured charge of the first battery. The length of the predefined period of time may depend upon the previously measured rate of change of the charge in the battery while discharging. For example, the predefined period of time may depend upon how long the battery took to drop below the first threshold value the last time it was charged. Also, the predefined period of time may depend upon an average length of time the battery has taken to drop below the first threshold value each time it was charged.

In these ways, an engine according to the invention, or a method according to the invention, can adapt according to the changing circumstances of the battery. For example, as the battery ages, it may tend to discharge faster. Similarly, the temperature of the battery and the settings of the electrical settings in the vehicle may cause a change in the time taken for the battery to drop below the first threshold.

The predefined period of time may depend upon the measured charge in the first battery. For example, the predefined period of time may be longer if the charge is higher. The length of the predefined period of time may be related to the charge level by an equation, or the length of the predefined period may be defined by the location of the charge level in the first battery with respect to at least one further threshold level.

The first threshold value may be 80% of the charge of the first battery when it is fully charged. The first threshold value may be 50% of the charge of the first battery when it is fully charged. The third threshold value may be 50% of the charge of the second battery when it is fully charged. The third threshold value may be 20% of the charge of the second battery when it is fully charged.

Typically, the voltage produced by a battery depends at least in part upon the state of charge in the battery. It may be that the first charge level monitoring device measures the voltage across two terminals on the first battery.

The voltage of the first battery may be converted into a state of charge using a calculation or a look up table. Alternatively, the first, second, third, fourth, seventh and any further threshold levels may each be expressed in terms of a voltage and the control unit may be configured to compare the measured voltage of the first battery to the threshold level directly. Similarly, the fifth and sixth threshold values may be expressed in terms of a change in charge over time, or in terms of a change in voltage over time.

It may be that the first battery is a 12 volt battery. It may be that the first threshold is 12.5 volts.

The voltage produced by a battery also typically depends upon the temperature of the battery. Therefore, the first charge level monitoring device may also measure the temperature of the first battery. Similarly, the first or second charge level monitoring device may measure the temperature of the second battery. Then, if a voltage is converted into a charge level, the charge level may be based upon both the voltage and the temperature of a battery. Alternatively, the threshold levels may be arranged to vary with a measured temperature, such as the temperature of the first battery or the temperature of the second battery. Therefore the control unit or the method can take account of the changes in voltage due to temperature.

It may be that the first charge level monitoring device measures current flowing from or to the battery. It may be that the first charge level monitoring device monitors the charge level by coulomb count or a CAN signal, or by any other suitable method. In a typical embodiment, the second battery has a voltage when fully charged which is higher than voltage of the first battery when fully charged. It may be that the second battery is intended to provide power to a motor which in turn drives the wheels in an electric or hybrid vehicle. It may be that the first battery has a voltage when fully charged which is higher than voltage of the second battery when fully charged. Alternatively it may be that the first battery has a voltage when fully charged which is substantially the same as the voltage of the second battery when fully charged.

It may be that the engine comprises a voltage level converter connected to the first battery and the second battery such that the second battery can be used to charge the first battery via the voltage level converter. The voltage level converter may be a DC/DC converter. The voltage level converter may be a bi-directional converter.

It may be that the first battery is a lead-acid battery. Alternatively the first battery may be a nickel metal hydride battery, or a lithium ion battery or any other suitable type of battery or collection of batteries. It may be that the second battery is a nickel metal hydride battery. Alternatively the second battery may be a nickel metal hydride battery, a lithium ion battery, a lead-acid battery or any other suitable type of battery or collection of batteries.

A third aspect of this invention provides a vehicle which comprises an engine as described above.

A fourth aspect of this invention provides a control unit for use in an engine, the control unit being arranged to carry out the method as described above.

### BRIEF DESCRIPTION OF THE DRAWINGS

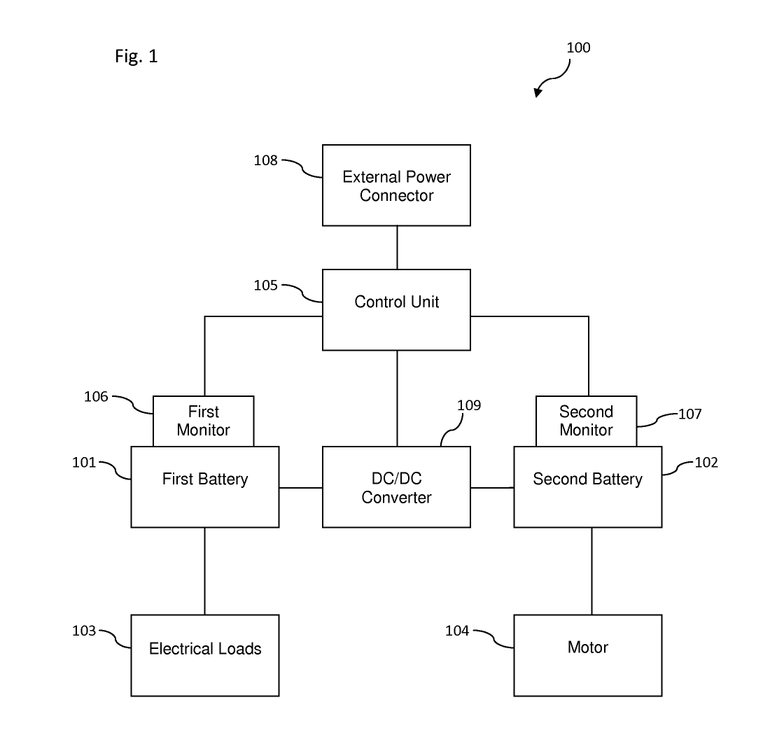

Exemplary embodiments of the invention are further described hereinafter with reference to the accompanying drawings, in which FIG. 1 is a diagram of an engine according to the invention.

### DETAILED DESCRIPTION

FIG. 1 shows a diagram of an engine 100 according to the invention. The engine is intended for use in an electrical vehicle, in particular a car. The engine comprises a first battery 101 and a second battery 102. The first battery 101 is a 12 volt battery and supplies power to a plurality of electrical loads 103. The electrical loads 103 include the vehicle's steering, key detection systems and a number of other systems, some of which are essential to the operation of the vehicle.

The second battery 102 is a higher voltage battery than the first battery 101. The second battery 102 supplies power to a traction motor 104. The motor is used to transform electrical power from the second battery 102 into mechanical force which can be used to move the vehicle. During braking, the motor can also be used to charge the second battery 102.

The engine has an on mode and an off mode. In the off mode, the motor 104 does not operate and the electrical load upon the batteries is generally reduced. However, some of the electrical loads 103 draw a quiescent current I_{Q} from the first battery 101 even when the engine 100 is turned off. This current supports the functions of systems which cannot turn off completely, for example because they must track the passage of time, or sense the operation of a remote key. Therefore, when the engine 100 is turned off, the charge stored in the first battery 101 gradually decreases.

The engine 100 further comprises a control unit 105, which monitors the first battery 101 using a first monitor 106. The first monitor 106 is a battery monitoring system, and can measure a number of characteristics of the first battery 101. In particular, the first monitor 106 can measure the voltage across two terminals of the first battery 101, and the first monitor 106 can measure the temperature of the first battery 101.

The control unit 105 further monitors the second battery 102 with a second monitor 107, which is similar to the first monitor 106.

When the engine 100 is turned off, the control unit 105 sets a timer and enters a sleep mode. When an hour has passed since the engine was turned off, the control unit 105 wakes up, and causes the first monitor 106 to measure the voltage across two terminals of the first battery 101. The first monitor 106 also measures the temperature of the first battery 101. The first monitor 106 then reports the measured voltage and temperature to the control unit 105.

The control unit 105 compares the measured voltage across two terminals of the first battery 101 with a first threshold value. The first threshold value represents a minimum charge level for the battery, and the first threshold value depends upon the temperature of the battery. This is because the voltage produced by the first battery 101 will vary with both the charge level of the battery and the temperature of the battery.

If the measured voltage across the two terminals of the first battery 101 is at or above the first threshold value then this indicates that the first battery 101 has an adequate amount of charge. The control unit 105 then re-sets the timer and re-enters the sleep mode. After an hour, the control unit 105 wakes up and checks the charge of the first battery 101 again, as described above.

If the measured voltage across the two terminals is beneath the first threshold value then this indicates that the first battery 101 is running low on charge. The control unit 105 therefore seeks to charge the first battery 101.

To charge the first battery 101, the control unit 105 first checks to see if power is available through an external power connector 108. The external power connector is a plug which is accessible on the exterior of the vehicle for connecting the vehicle to a charging station while parked. If the external power connector 108 is plugged into an external power source, then the control unit 105 causes the first battery 101 to be charged from the external power connector until the voltage across two terminals on the first battery 101 is above a second threshold value. The second threshold value is above the first threshold value. The control unit 105 then re-sets the timer and re-enters the sleep mode. After an hour, the control unit 105 wakes up and checks the charge of the first battery 101 again, as described above.

If power is not available through the external power connector 108, then the control unit 105 causes the second monitor 107 to measure the voltage across two terminals of the second battery 102 and the temperature of the second battery 102. The second monitor 107 then reports the measured voltage and temperature to the control unit 105.

The control unit 105 compares the measured voltage across two terminals of the second battery 102 with a third threshold value. Again, the threshold value represents a minimum charge level for the battery, and the second threshold value chosen depends upon the temperature of the battery.

If the measured voltage across the two terminals of the second battery 102 is at or above the third threshold value, indicating that the second battery 102 has an adequate amount of charge, then the control unit 105 causes the second battery 102 to charge the first battery 101. The second battery 102 charges the first battery 101 through a DC/DC converter 109 which converts high voltage current from the second battery 102 to low voltage current suitable for the first battery 101.

The second battery 102 continues to charge the first battery 101 until the voltage across two terminals on the first battery 101 rises above the second threshold value, indicating that the first battery 101 is adequately charged. The control unit 105 then re-sets the timer and re-enters the sleep mode for a further predefined period of time.

If the measured voltage across the two terminals of the second battery is beneath the third threshold value, or if it drops below this value while the second battery 102 is charging the first battery 101, then this indicates that the second battery 102 is running low on charge, and that the remaining charge in the second battery 102 is too low for it to be used to charge the first battery 101. The control unit 105 then ceases any charging and returns to a sleep mode in order to minimise power consumption. The control unit 105 then remains in a sleep mode until either an external power connector is connected and used to charge at least one of the batteries 101, 102, or the vehicle is turned on.

The control unit 105 therefore checks upon the charge level of the first battery 101 periodically and, if the charge level is too low, seeks to remedy this. If no external power source is available, then the control unit 105 can charge the first battery 101 with power from the second battery 102.

By only checking on the first battery periodically, the control unit 105 minimises the power consumed in monitoring the first battery 101.

In the engine 100, the control unit is also set to periodically wake up and check on the second battery 102, once an hour. The control unit can therefore check on both batteries at the same time.

Depending upon the vehicle, I_{Q} is typically very small. As a result, it may not be necessary to check upon the first battery 101 every hour. Therefore the length of time which the control unit 105 waits between checks can be set by an engineer when the engine is first set up, or by an engineer or a user at a later date. For example, the control unit can be set to sleep for six hours between checks. In this instance, the control unit 105 can still check on the first battery 101 at the same time as it checks upon the second battery 102, in order to minimise the power used. So, for example, the second battery 102 may still be checked hourly, and every sixth time the second battery 102 is checked, the first battery 101 is also checked. The control unit 105 can also be set to wait for a day between checks, or for a week, or any other length of time which is desired.

The length of time which the control unit 105 spends asleep may also vary with time. For example, the control unit 105 can be set to sleep for four days when the vehicle is first turned off, then one day, and then one hour. The control unit 105 will then wake up every hour to check the charge of the first battery 101. This cycle continues until such time as the first battery 101 needs to be charged. If the first battery 101 is charged, the control unit 105 then begins the cycle again, sleeping for four days, then one day, then an hour and so on. If the first battery 101 cannot be charged, then the control unit 105 goes to sleep until the battery can be charged or the vehicle is started again, as described above.

The control unit 105 is also configured to provide a warning to the user in certain circumstances. Firstly, the control unit 105 is configured to provide a warning to the user if the first battery 101 cannot be charged because no external power source is available and the charge in the second battery 102 is too low. Secondly, the control unit 105 is configured to record the changes in the voltage produced by the first battery 101 over time, and so calculate the rate of change in voltage of the first battery 101 while discharging. The control unit 105 is configured to provide a warning to the user if the rate of change in voltage of the first battery 101 while discharging is above a fifth threshold. Thirdly, the control unit 105 is configured to calculate the rate of change in voltage of the first battery 101 while charging. The control unit 105 is configured to provide a warning to the user if the rate of change in voltage of the first battery 101 while charging is below a sixth threshold.

The warnings are in the form of a message which is displayed to the user, for example on the dashboard of the vehicle. The user can then take actions to charge the first battery 101 and the second battery 102 or have them inspected by an engineer. If the user wishes, they can configure the control unit to provide a remote message, such as a text message sent to a mobile phone, so that the user knows when their vehicle may need to be charged or inspected.

In a second embodiment, the time which the control unit 105 waits between checks is not fixed. Instead, the time is related to the measured charge in the first battery 101, such that if the charge in the first battery 101 is higher, then the time waited before the next check is longer. The control unit 105 may also be configured to record the time taken for the first battery 101 to drop below the first threshold each time, and wait a period of time related to those records. For example, if the records show that the first battery 101 takes an average of a week to discharge, the control unit 105 may sleep for six days before first checking the charge, and then check hourly until such time as the voltage across two terminals of the first battery 101 drops below the first threshold.

Combinations of the above patterns are also possible. For example, the control unit 105 may be configured to sleep for five days when the vehicle is first turned off, and then to sleep for a period of time dependent upon the measured charge of the first battery 101 thereafter.

In a third embodiment, an engine according to the invention is a hybrid engine, which is capable of driving itself both by electrical power from a battery and by consuming fuel. The hybrid engine still comprises two batteries, and functions in the way described above in relation to an electrical vehicle.

The embodiments above describe monitoring battery charge and the state of health of the battery in primarily through monitoring voltage. However an engine according to the invention may comprise at least one battery monitor which monitors other aspects of the battery, including but not limited to current flow, temperature, and time to charge. For example the state of charge of a battery may be monitored using a coulomb count or a CAN signal.

The embodiments above relate to electrical vehicles and hybrid vehicles. However, any engine with at least two batteries can make use of the invention described above, functioning in the way described above in relation to an electrical vehicle.

It is to be noted that the term “sleep” used above is simply a convenient and well known reference to a low-power mode of operation of the engine or its components, when most of the engine's systems are deactivated but not completely disabled. The present invention also comprises a vehicle incorporating an engine as described above.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An engine, the engine having a first mode and a second mode, the engine comprising:
a first battery;
a second battery;
a first charge level monitoring device attached to the first battery; and
a control unit,
wherein the control unit is arranged to:
measure a charge level of the first battery using the first charge level monitoring device when the engine is in the second mode; and
cause the second battery to charge the first battery if the charge level of the first battery is beneath a first threshold value.

2. The engine of claim 1, wherein the control unit is arranged to measure a charge level of the second battery and cause the second battery to charge the first battery only if the charge level of the second battery is above a third threshold value.

3. The engine of claim 1, wherein the second battery is arranged to charge the first battery only if the engine is not connected to an external power source.

4. The engine of claim 1, wherein the control unit is further arranged to wait a predefined period of time after measuring the charge level of the first battery before measuring the charge level of the first battery again.

5. The engine of claim 4, wherein the control unit is further arranged to select a length of the predefined period of time dependent upon the measured charge level of the first battery.

6. The engine of claim 4, wherein the control unit is further arranged to select a length of the predefined period of time dependent upon a previously measured rate of change of the charge level of in the first battery.

7. The engine of claim 1, wherein the first charge level monitoring device is arranged to measure voltage across two terminals on the first battery.

8. The engine of claim 1, wherein the first charge level monitoring device is arranged to measure a temperature of the first battery.

9. The engine of claim 1, wherein the second battery has a voltage when fully charged which is higher than a voltage of the first battery when fully charged.

10. The engine of claim 9, further comprising a voltage level converter connected to the first battery and the second battery such that the second battery can be used to charge the first battery via the voltage level converter.

11. A vehicle comprising the engine of claim 1.

12. A method for charging a battery in an engine, the engine having a first mode and a second mode, and the engine comprising:
a first battery;
a second battery;
a first charge level monitoring device attached to the first battery; and
a control unit,
the method comprising:
measuring a charge level of the first battery using the first charge level monitoring device when the engine is in the second mode; and
causing the second battery to charge the first battery if the charge level of the first battery is beneath a first threshold value.

13. The method of claim 12, further comprising:
measuring a charge level of the second battery; and
causing the second battery to charge the first battery only if the charge level of the second battery is above a third threshold value.

14. The method of claim 12, further comprising charging the first battery only if the engine is not connected to an external power source.

15. The method of claim 12, the method further comprising waiting a predefined period of time after measuring the charge level of the first battery before measuring the charge level of the first battery again.

16. The method of claim 15, wherein a length of the predefined period of time depends upon the charge level of the first battery.

17. The method of claim 15, wherein a length of the predefined period of time depends upon a previously measured rate of change of the charge level of the first battery while discharging.

18. The method of claim 12, wherein the first charge level monitoring device is arranged to measure a voltage across two terminals on the first battery.

19. The method of claim 12, wherein the first charge level monitoring device is arranged to measure a temperature of the first battery.

20-21. (canceled)

22. A control unit for use in an engine, the control unit being arranged to carry out the method of claim 12.
